(19) United States
(12) Patent Application Publication
(10) Pub. No.: US 2026/0178594 A1
(43) Pub. Date: Jun. 25, 2026

(54) APPARATUS AND METHOD WITH VISUAL QUESTION ANSWERING

(71) Applicant: SAMSUNG ELECTRONICS CO., LTD., Suwon-si (KR)

(72) Inventor: Ju Hwan SONG, Suwon-si (KR)

(73) Assignee: SAMSUNG ELECTRONICS CO., LTD., Suwon-si (KR)

(21) Appl. No.: 19/230,806

(22) Filed: Jun. 6, 2025

(30) Foreign Application Priority Data
Dec. 24, 2024 (KR) 10-2024-0195614

(51) Int. Cl. G06F 16/2457; G06F 16/9032; G06F 16/9038; G06F 16/93

(52) U.S. Cl. CPC G06F 16/24578; G06F 16/90332; G06F 16/9038; G06F 16/93

(57) ABSTRACT

An apparatus and method with visual question answering (VQA) are provided. the VQA apparatus receives a document including visual content and a query input including a user's question about the document, obtains summary information summarizing a portion of the document and location information indicating a location of the portion using a summary information generation model that receives the document as input, generates context data including the summary information and the location information, obtains location information on a candidate location in the document related to the user's question using a candidate location extraction model, obtains a response corresponding to the user's question using a VQA model that receives the visual content in the document corresponding to the candidate location and the user's question as input, and provides the obtained response.

### CROSS-REFERENCE TO RELATED APPLICATIONS

This application claims the benefit under 35 USC § 119(a) of Korean Patent Application No. 10-2024-0195614, filed on Dec. 24, 2024, in the Korean Intellectual Property Office, the entire disclosure of which is incorporated herein by reference for all purposes.

### BACKGROUND

### 1. Field

The following description relates to an apparatus and method with visual question answering.

### 2. Description of Related Art

Visual question answering (VQA) technology may generate answers to a user's question about visual data (e.g., image data or video data). VQA technology may generate answers to a user's question using a machine learning model. VQA technology may use a multi-modal base model to simultaneously process different types of input data (e.g., visual data and a user's question in text format about visual data).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a computing apparatus includes: one or more processors; and a memory storing instructions configured to cause the one or more processors to: receive a document including graphic content and receive a query input including a user's question about the document, obtain summaries of respective portions of the document and locations of the respective portions within the document using a summary information generation model that performs inference on the document as input thereto, generate context data including the summaries and the locations respectively corresponding to the portions, obtain a candidate location in the document related to the user's question using a candidate location extraction model that infers the candidate location based on a prompt requesting the candidate location in the document related to the user's question, the context data, and the user's question, which are received as input to the candidate location extraction model, obtain a response corresponding to the user's question using a visual question answering (VQA) model that receives the graphic content in the document corresponding to the candidate location and the user's question as input, and provide the obtained response.

The instructions may be further configured to cause the one or more processors to, obtain candidate locations, including the candidate location, in the document related to the user's question using the candidate location extraction model, obtain candidate responses corresponding to the user's question using the VQA model that receives each items of graphic content in the document respectively corresponding to the candidate locations and the user's question as input, select one of the candidate responses as the obtained response.

The instructions may be further configured to cause the one or more processors to obtain response confidences indicating confidences of the candidate responses, respectively, using the VQA model, and select the one of the candidate responses based on it having the highest response confidence among the response confidences of the candidate responses.

The instructions may be further configured to cause the one or more processors to obtain response confidences indicating confidences of the candidate responses, respectively, using a confidence estimation model that estimates the response confidence of each of the candidate responses with respect to the user's question, and select the one of the candidate responses based on it having the highest response confidence among the response confidences of the candidate responses.

The instructions may be further configured to cause the one or more processors to obtain the summaries and the locations by inputting a prompt defining a scheme of generating the summaries to the summary information generation model together with the document.

The instructions may be further configured to cause the one or more processors to obtain the response confidences by inputting a prompt defining a representation scheme of the response confidences to the VQA model together with each of the items of graphic content and the user's question.

The prompt defining the scheme of generating the summary information may specify that the summary information is to include a location within the document of a portion to be summarized in the document and content summarizing the portion to be summarized in the document.

The prompt defining the scheme of generating the summary information may specify that the summary information is to include a title of the document to be summarized, a keyword for the document, and/or a description of graphic material included in the document.

The instructions may be further configured to cause the one or more processors to, encode a resolution of the graphic content existing at the candidate location in the document into higher resolution graphic content, and obtain the response using the VQA model that receives the higher resolution graphic content as input.

The instructions may be further configured to cause the one or more processors to, generate the context data including page information indicating a page number of a page including a portion of the document that is summarized, coordinate information including coordinates of a point at which a paragraph included in the portion starts and coordinates of a point at which the paragraph ends, and the summary.

In another general aspect, a visual question answering (VQA) method is performed by a computing apparatus, and the method includes: receiving a document including graphic content and a query input including a user's question about the document; obtaining summaries of respective portions of the document and locations of the respective portion within the document using a summary information generation model that performs inference on the document as input thereto; generating context data including the summaries and the locations respectively corresponding to the portions; obtaining a candidate location in the document related to the user's question using a candidate location extraction model that infers the candidate location based on a prompt requesting the candidate location in the document related to the user's question, the context data, and the user's question, which are received as input to the candidate location extraction model; obtaining a response corresponding to the user's question using a visual question answering (VQA) model that receives the graphic content in the document corresponding to the candidate location and the user's question as input; and providing the obtained response.

The obtaining of the location information on the candidate location in the document may include obtaining candidate locations, including the candidate location, in the document related to the user's question using the candidate location extraction model, obtaining candidate responses corresponding to the user's question using the VQA model that receives each items of graphic content in the document respectively corresponding to the candidate locations and the user's question as input, selecting one of the candidate responses as the obtained response.

The method may further include: obtaining response confidences indicating confidences of the candidate responses, respectively, using the VQA model, and selecting the one of the candidate responses based on it having the highest response confidence among the response confidences of the candidate responses.

The method may further include: obtaining response confidences indicating confidences of the candidate responses, respectively, using a confidence estimation model that estimates the response confidence of each of the plurality of candidate responses with respect to the user's question, and selecting the one of the candidate responses based on it having the highest response confidence among the response confidences of the candidate responses.

The method may further include obtaining the summaries and the locations by inputting a prompt defining a scheme of generating the summaries to the summary information generation model together with the document.

The method may further include obtaining the response confidences by inputting a prompt defining a representation scheme of the response confidences to the VQA model together with each of the items of graphic content and the user's question.

The prompt defining the scheme of generating the summary information may specify that the summary information is to include a location within the document of a portion to be summarized in the document and content summarizing the portion to be summarized in the document.

The prompt defining the scheme of generating the summary information may specify that the summary information is to include a title of the document to be summarized, a keyword for the document, and/or a description of graphic material included in the document.

The obtaining of the response may include encoding a resolution of the graphic content existing at the candidate location in the document into higher resolution graphic content, and obtaining the response using the VQA model that receives the higher resolution graphic content as input.

The method may further include generating the context data including page information indicating a page number of a page including a portion of the document that is summarized, coordinate information including coordinates of a point at which a paragraph included in the portion starts and coordinates of a point at which the paragraph ends, and the summary.

Other features and aspects will be apparent from the following detailed description, the drawings, and the claims.

### BRIEF DESCRIPTION OF THE DRAWINGS

FIG. 1 illustrates an example of a visual question answering (VQA) apparatus, according to one or more embodiments.

FIG. 2 illustrates an example of operations of a VQA method, according to one or more embodiments.

FIG. 3 illustrates an example of operations for performing a VQA method based on candidate locations, according to one or more embodiments.

FIG. 4 illustrates an example of obtaining context data using a summary information generation model, according to one or more embodiments.

FIG. 5 illustrates an example of generating context data, according to one or more embodiments.

FIG. 6 illustrates an example of obtaining location information using a candidate location extraction model, according to one or more embodiments.

FIG. 7 illustrates an example of obtaining location information, according to one or more embodiments.

FIGS. 8A and 8B illustrate examples of obtaining a first response and a first response confidence of the first response using a VQA model, according to one or more embodiments.

FIGS. 9A and 9B illustrate examples of obtaining a second response and a second response confidence of the second response using a VQA model, according to one or more embodiments.

FIG. 10 illustrates an example of configurations of a VQA apparatus, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

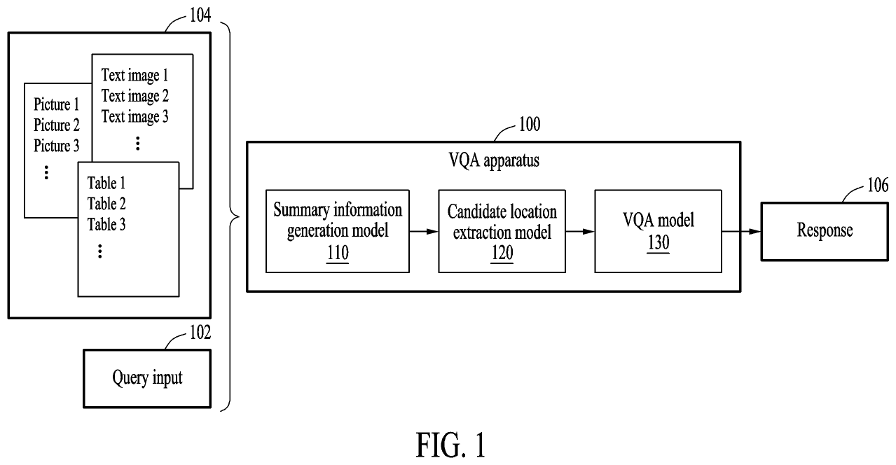

FIG. 1 illustrates an example of a visual question answering (VQA) device, according to one or more embodiments.

Referring to FIG. 1, a VQA apparatus 100 may generate a response 106 to a user's question/query about an input document 104 (e.g., an image document). Different types/modes of data may be input to the VQA apparatus 100, and a multi-modal base model may be used to provide the response 106. The VQA apparatus 100 may use relatively short-length context data rather than uploading all pages of the input document 104. The VQA apparatus 100 may input the short-length context data to the multi-modal base model to obtain the response 106, thereby reducing the time required to obtain the response 106 compared to inputting the entire document 104 to the multi-modal base model. The multi-modal base model may be a machine learning model that receives different modalities as input and provides responses to users'questions (or requests) based on the relationships between the different modalities. A modality may be a form or manner in which data is represented (e.g., a datatype). For example, the modality may include text data, image data, audio data, or video data. Multi-modal data may include multiple modalities. For example, the multi-modal data may include text data and image data. The VQA apparatus 100 may perform various tasks depending on an input document and a user's question (or a user's request). For example, when an input including a document including a text image and including a user's question (e.g., “Could you please tell me the expenditure statistics for 2024 from the contents included in the document?”) is inputted to the VQA apparatus 100, the VQA apparatus 100 may provide the expenditure statistics for the year 2024 among the contents of the text image included in the input document. For example, when a document including an image of a product for sale and a user's question (e.g., “Could you please tell me about the products and organize their prices in ascending order?”) are input to the VQA apparatus 100, the VQA apparatus 100 may provide information about the products included in the input document and the prices of the products organized in ascending order.

The VQA apparatus 100 may save resources required to obtain the response 106 by tokenizing only a portion of the input document 104 (or text derived therefrom) necessary to provide the response 106 to the user's question rather than generating image tokens for the entire input document 104. Additionally, the VQA apparatus 100 may improve the resolution of a portion or a page of a document by encoding the portion or page of the document necessary to provide the response 106. For example, the VQA apparatus 100 may improve the resolution of the portion or page of the document through an encoding scheme using interpolation that increases the pixels of the portion or page of the document to improve the resolution thereof, or edge enhancement that emphasizes edge portions of the document to improve the resolution thereof. The VQA apparatus 100 may improve the accuracy and speed of the multi-modal base model's response by inputting, a portion or page of the document with improved resolution obtained by encoding the portion or page of the document required for the response 106, to the multi-modal base model.

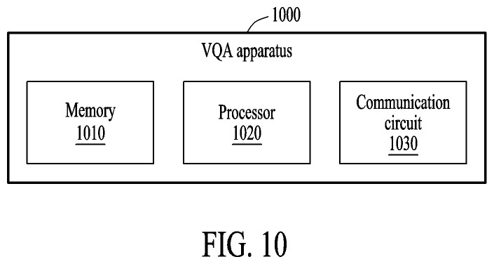

In an example, the VQA apparatus 100 may receive the document 104 and a query input 102. For example, the VQA apparatus 100 may receive the document 104 and the query input 102 input through a user interface (e.g., a graphical user interface) via a communication circuit (e.g., a communication circuit 1030 of FIG. 10). The VQA apparatus 100 may provide the response 106 in response to receiving the document 104 and the query input 102. The document 104 may include visual content. The visual content may convey information through sight. For example, the document 104 may include, a text image, a table image, a picture, or any combination thereof, but is not limited thereto. The query input 102 may be a command or data for requesting information. For example, the query input 102 may include, but is not limited to, a user's question about the document 104. The response 106 may be an output result of the VQA apparatus 100 in response to the input document 104 and the user's question. The response 106 may vary depending on the user's question included in the query input 102. For example, when a user's question input to the VQA apparatus 100 is a request to summarize the contents of an input document, the VQA apparatus 100 may output a text summarizing the contents of the document as the response 106. When a user's question input to the VQA apparatus 100 is a request to extract only a graph from the input document, the VQA apparatus 100 may output a graph image included in the document as the response 106.

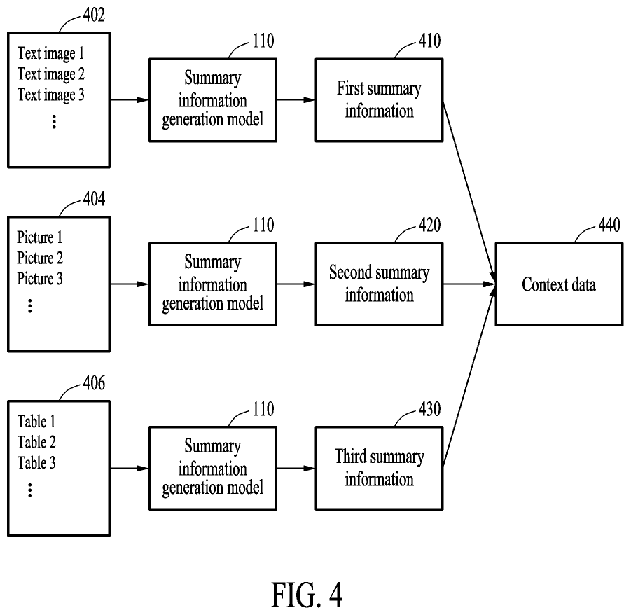

In an example, the VQA apparatus 100 may obtain summary information summarizing a portion of the document 104 and location information indicating a location of the summarized portion within the document 104 using a summary information generation model 110 that receives the document 104 as input. For example, the VQA apparatus 100 may obtain summary information on visual content included in the document 104 and location information indicating a location of the visual content. The obtaining of the summary information and the location information indicating the location of the visual content using the summary information generation model 110 performed by the VQA apparatus 100 is described in more detail with reference to FIG. 4.

The VQA apparatus 100 may generate context data (e.g., context data 440 of FIG. 4) including summaries (summary information) for respective portions of the document 104 and location information corresponding to each of the summarized portions. The summary information may be information summarizing a portion of a document or a page of a document to be summarized. The portion or page of the document to be summarized may be a portion or a page of a document that the VQA apparatus 100 uses to respond to a user's question.

The VQA apparatus 100 may obtain location information on a candidate location within the document 104 related to a question using a candidate location extraction model 120 that receives a prompt requesting the candidate location in the document 104 related to the user's question, the context data, and the user's question as input. The candidate location within the document 104 related to the user's question may be a location among the locations included in the location information obtained from the summary information generation model 100 that may be used to determine the response 106 to the user's question.

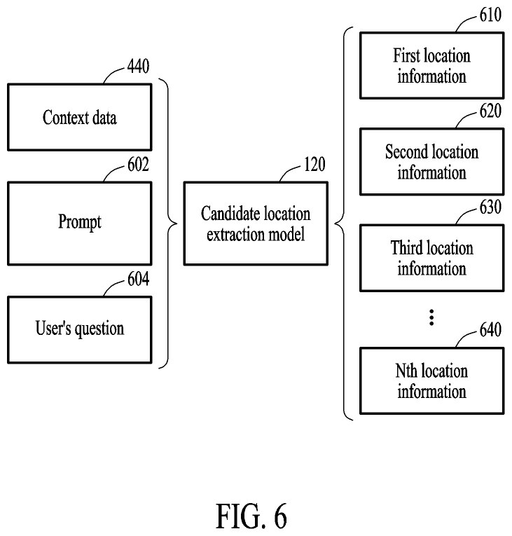

The location information for the candidate location in the document 104 may include pieces of location information. The obtaining of the pieces of location information by the VQA apparatus 100 is described in more detail with reference to FIG. 6.

The VQA apparatus 100 may obtain the response 106 corresponding to the user's question using a VQA model 130 that receives as input visual content in the document 104 corresponding to a candidate location and the user's question, and may provide the obtained response 106. The VQA apparatus 100 may obtain responses from the VQA model 130 and obtain respectively corresponding response confidences. A response confidence may be a numerical value that indicates how appropriate the corresponding response is to the user's question.

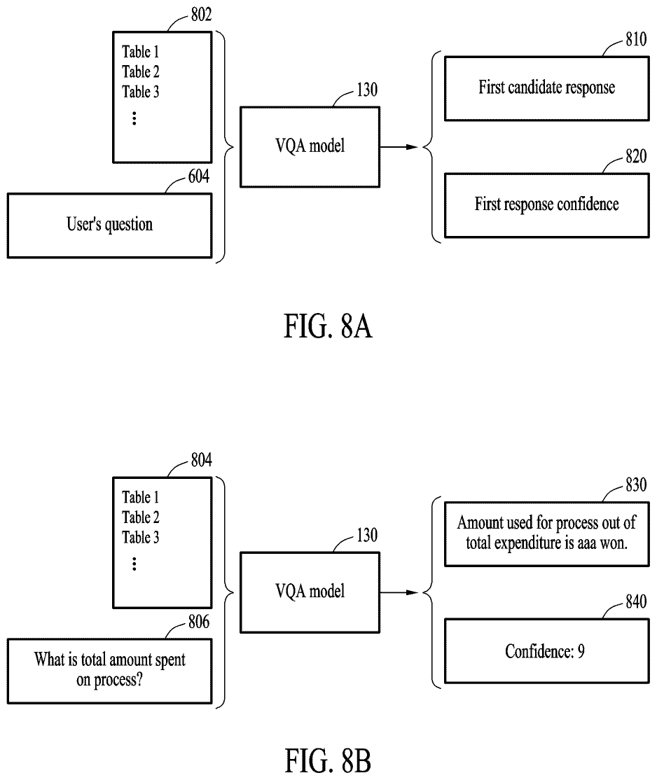

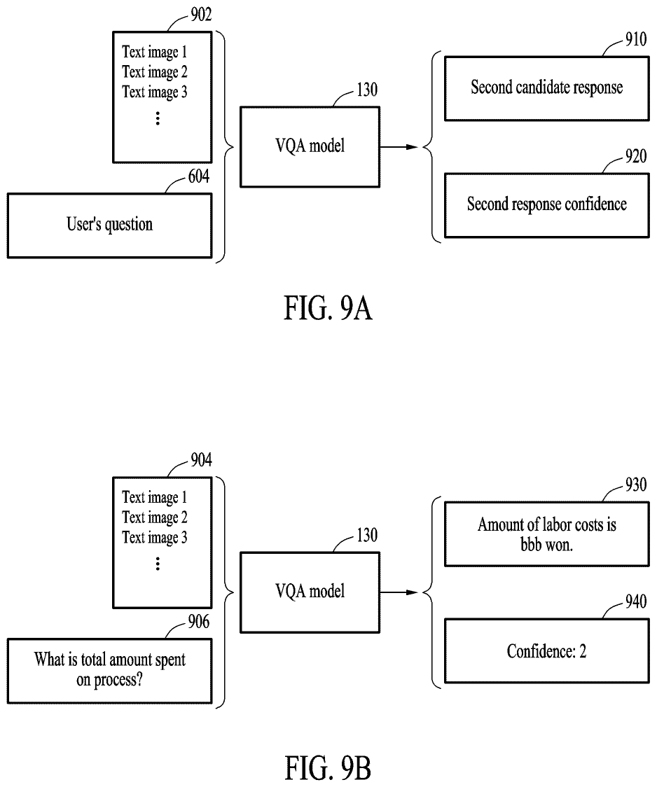

The VQA apparatus 100 may determine that a response having, for example, the highest response confidence is to be provided to the user. The VQA apparatus 100 providing the response 106 using the VQA model 130 is described in more detail with reference to FIGS. 8A, 8B, 9A and 9B.

In an example, the summary information generation model 110, the candidate location extraction model 120, and the VQA model 130 included in the VQA apparatus 100 may be machine learning models (e.g., neural networks) based on a multi-modal base model. General information about the multi-modal base model follows.

The multi-modal base model may be a machine learning model that receives different modalities as input and provides responses to users'questions (or requests) based on the relationships between the different modalities. A modality may be a form or manner in which data is represented. For example, the modality may include text data, image data, audio data, or video data. Multi-modal data may include multiple modalities. For example, the multi-modal data may include text data and image data.

The multi-modal base model may include interconnected layers of nodes. For example, the multi-modal base model may include an input layer to which modalities (or input data) are input, feature extraction layer(s) that extracts features from the input modalities, a feature fusion layer that fuses the extracted features, a hidden layer that processes a requested task using an activation function, and an output layer that outputs a response based on a result value output by the hidden layer.

The multi-modal base model may perform preprocessing on input multi-modal data, extract features from the preprocessed multi-modal data, fuse the extracted features, infer results for user requests using the fused features, and output the results. The multi-modal base model may further include a process for evaluating the output results. The preprocessing process for the multi-modal data may include synchronizing different types of data included in the multi-modal data. The process of synchronizing different types of data may be forming temporal and/or logical connections between modalities. The preprocessing process may include generating temporal or logical relationships between modalities, as well as performing different preprocessing processes depending on the type of modality. For example, the preprocessing process may include tokenizing the modality when the modality is text data, normalizing and embedding the tokenized text data, and resizing and converting the format of an image when the modality is image data. When the modality is audio data, the preprocessing process may include removing noise from an audio signal and frequency converting the audio signal (e.g., transforming to the frequency domain). The process of extracting features from multi-modal data may be performed using a machine learning model. For example, when the modality is text data, a natural language processing model may be used to extract linguistic features, when the modality is image data, a convolutional model may be used to extract image features, and when the modality is audio data, a recurrent neural network may be used to extract features of the audio data. The process of fusing the extracted features may be fusing the extracted features to generate inputs to be used in the multi-modal base model. For example, fusion data in which linguistic features and image features extracted from each modality are fused may be used as an input to the multi-modal base model. The fusing of the features may be performed by concatenating feature vectors, fusion using self-attention or cross-attention, or tensor fusion which represents relationships between modalities using tensors.

The multi-modal base model may be optimized/configured differently depending on the characteristics of a task and a format of the input data. For example, when data input to the multi-modal base model is image-text fusion data, the multi-modal base model may be a cross-attention-based multi-modal base model (e.g., vision-and-language bidirectional encoder representations from transformers (ViLBERT) or visual bidirectional encoder representations from transformers (VisualBERT)) that is optimized for processing image-text fusion data. The cross-attention-based multi-modal base model may be trained by using the characteristics of input modalities and the correlations between the modalities, and the trained cross-attention-based multi-modal base model may provide a more accurate response 106 when the modalities are image data and text data.

The VQA apparatus 100 may improve the speed at which the VQA apparatus 100 responds to a user's question by allowing the multi-modal base model (e.g., a multi-modal large language model (MM-LLM)) to receive a multi-page document 104 as input and to use candidate locations instead of using all pages of the document 104. A candidate location may be a location within the document 104 that may be used to answer a question input by the user. For example, the VQA apparatus 100 may improve the speed at which the VQA apparatus 100 provides a response to the user's question by selectively encoding a portion of the document 104 that may be used for the response 106 to the question input by the user, rather than encoding all pages within the document 104. The VQA apparatus 100 may generate summary information summarizing a portion of the document 104 to determine candidate locations. The VQA apparatus 100 may save resources of the VQA apparatus 100 by inputting only a portion or a page of the document 104 necessary to process the user's question to the multi-modal base model (e.g., the VQA model 130) using the summary information.

The VQA apparatus 100 may generate image tokens for portions corresponding to candidate locations in the input document 104, rather than generating image tokens for all pages of the document 104. This may be suitable, for example, when the input document 104 has a high resolution. The image tokens may represent an input image divided into predetermined units that may be used in a machine learning model. For example, the image token may correspond to a patch that segments an image. The VQA apparatus 100 may reduce the length of context data input to the multi-modal base model using only the image tokens for a portion of an image required for (or relevant to) the response 106. By reducing the length/amount of the context data input to the multi-modal base model, the amount of data to be processed by the multi-modal base model may be reduced, thereby reducing the time taken by the VQA apparatus 100 to provide the response 106 to the user's question.

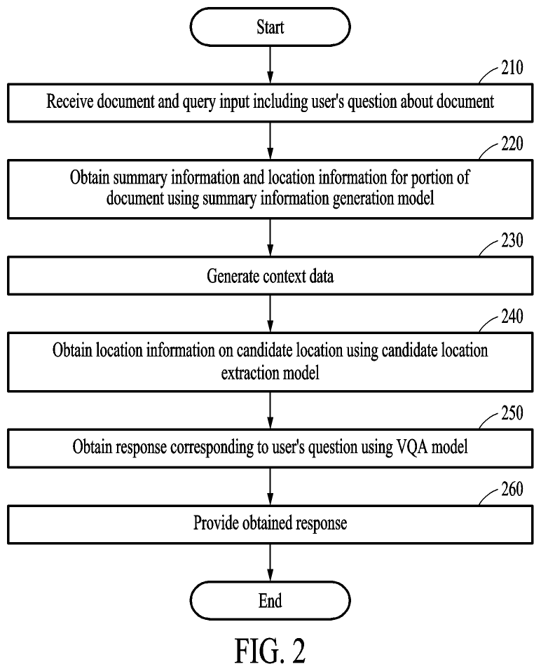

FIG. 2 illustrates an example of operations of a VQA method, according to one or more embodiments. The operations of the VQA method may be performed by a VQA apparatus (e.g., the VQA apparatus 100 of FIG. 1 or a VQA apparatus 1000 of FIG. 10).

Referring to FIG. 2, in operation 210, the VQA apparatus may receive a document (e.g., the document 104 of FIG. 1) and a query input (e.g., the query input 102 of FIG. 1) including a user's question about the document. The document may include visual content (e.g., text images). For example, the document may include, but is not limited to, content represented graphically, such as images, text images, or tables. The query input may include a user's question (including a user's request expressed in text). For example, the query input may be, but is not limited to, a request to summarize an input document, a question to determine whether an input document includes a particular object, or the like.

In operation 220, the VQA apparatus may summaries (summary information) and respective locations (location information) for respective portions of the document using a summary information generation model (e.g., the summary information generation model 110 of FIG. 1). The VQA apparatus may obtain the summary information and location information indicating locations of the portions within the document using the summary information generation model that receives the document as input. The summary information generation model may be a machine learning model (e.g., a multi-modal base model) that summarizes the content of an input document. An input of the summary information generation model may be a document including visual/graphical content, and an output of the summary information generation model may be summary information that summarizes a portion of the document or a page of the document. For example, the summary information generation model to which the document is input may output summary information summarizing the document by page or summary information summarizing a portion of each page, and may also output the summary information summarizing the document by page or the summary information summarizing the portion of each page together.

The VQA apparatus may input a prompt defining a scheme of generating the summary information to the summary information generation model together with the document. The prompt defining the scheme of generating the summary information may specify that the summary information is to include a location within the document of a portion to be summarized in the document and content summarizing the portion. For example, the prompt defining the scheme of generating the summary information may specify the summary information to include a title of the document to be summarized, a keyword for the document, and/or a description of visual material included in the document.

The VQA apparatus may obtain the summary information and the location information indicating the location of the portion. The location of the portion may be the location of the portion summarized in the document and may correspond to the summary information. The obtaining of the summary information using the summary information generation model is described in more detail with reference to FIG. 4.

In operation 230, the VQA apparatus may generate context data (e.g., the context data 440 of FIG. 4). The context data may be data including information included in input modalities and information on the correlations between the modalities. The VQA apparatus may generate pieces of context data (including summary information) for respective portions of the document and location information respectively corresponding to the portions. For example, when the VQA apparatus receives the document and the user's question, the VQA apparatus may generate the context data including page information, coordinate information, and summary information of the document. The page information may be a page number of a page in the document that includes a portion of the document to be summarized. For example, the page information may be a page number expressed in Arabic numerals or Roman numerals. The coordinate information may include coordinates of a point at which a paragraph included in a portion of the document begins and coordinates of a point at which the paragraph ends on a page that includes the portion of the document. For example, the coordinate information may be coordinates expressed in a rectangular coordinate system, such as the coordinates of the point at which the paragraph begins and the coordinates of the point at which the paragraph ends.

In operation 240, the VQA apparatus may obtain location information on a candidate location using a candidate location extraction model (e.g., the candidate location extraction model 120 of FIG. 1). The candidate location extraction model may be a machine learning model that outputs candidate locations that may be used to respond to a user's question from the location information obtained from the summary information generation model. The VQA apparatus may input a prompt requesting a candidate location within the document, context data, and the user's question to the candidate location extraction model, and obtain the location information on the candidate location within the document related to the question from the candidate location extraction model. The prompt requesting the candidate location within the document may request a location among the locations included in the location information obtained from the summary information generation model that may be used to determine a response to the user's question. For example, the prompt requesting the candidate location within the document may be “Tell me where in the document the section that matches the input question is located.” The obtaining of the location information on the candidate location by the VQA apparatus is described in more detail with reference to FIG. 6.

In operation 250, the VQA apparatus may obtain a response (e.g., the response 106 of FIG. 1) corresponding to the user's question using a VQA model (e.g., the VQA model 130 of FIG. 1). The VQA model may be a machine learning model that outputs a response corresponding to the user's question as determined/selected from among the candidate locations obtained from the candidate location extraction model. The VQA model may be a machine learning model based on a multi-modal base model. The VQA apparatus may obtain the response corresponding to the user's question by the VQA model receiving visual content in the document corresponding to a candidate location and the user's question as input. For example, the VQA apparatus may receive as input a document including a text image and a user's question (e.g., “Could you summarize the contents of pages 20 to 60 of the document paragraph by paragraph?”) to an MM-LLM, and obtain a paragraph by paragraph text summary from pages 20 to 60 of the document corresponding to the user's question from the MM-LLM. The VQA model may perform inference on the portions/locations of the document indicated by the candidate locations (and based on other input data such as the user's question).

In operation 260, the VQA apparatus may provide the obtained response. For example above, the VQA apparatus may provide the text summarized paragraph by paragraph from pages 20 to 60 of the document obtained in the example of operation 250 to an electronic device (e.g., a user terminal or a user computer) via a communication circuit (e.g., the communication circuit 1030 of FIG. 10).

The VQA apparatus may encode the resolution of visual content existing at a candidate location within the document into higher-resolution visual content (i.e., upscale), and input the higher-resolution visual content to the VQA model. The resolution may correspond to an ability of an image to display detail, and may be expressed as a relative number of pixels included in the image, for example. Encoding may include converting the format of data. The VQA apparatus may extract features of low-resolution visual content through encoding, convert the extracted features into features of high-resolution visual content, and generate high-resolution visual content using the features of the high-resolution visual content. The high-resolution visual content may have more pixels than the low-resolution visual content. The VQA apparatus may improve the response performance of the VQA model and reduce the inference time of the VQA model by using high-resolution visual content corresponding to candidate locations.

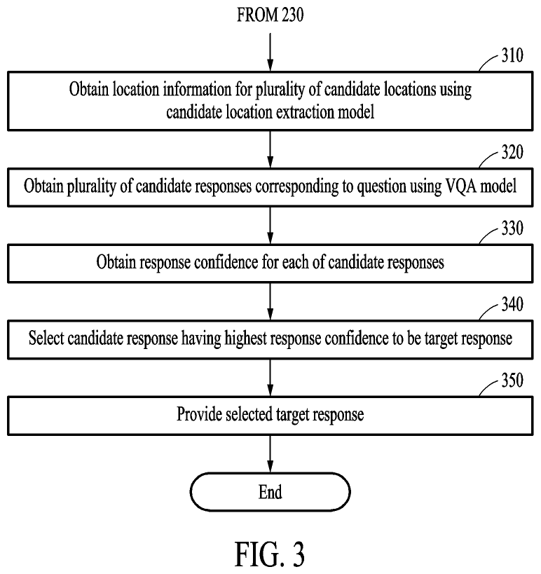

FIG. 3 illustrates an example of operations for performing a VQA method based on candidate locations, according to one or more embodiments. The operations of the VQA method may be performed by a VQA apparatus (e.g., the VQA apparatus 100 of FIG. 1 or a VQA apparatus 1000 of FIG. 10).

Referring to FIG. 3, after operation 230 of FIG. 2 is performed, in operation 310, the VQA apparatus may obtain pieces of location information for respective candidate locations using a candidate location extraction model (e.g., the candidate location extraction model 120 of FIG. 1). Operation 310 may be performed after operation 230 of FIG. 2 is performed. The VQA apparatus may obtain pieces of location information for respective candidate locations within a document related to a question using the candidate location extraction model. For example, the candidate locations may include a first candidate location, a second candidate location, up to an Nth candidate location. The obtaining of the candidate locations by the VQA apparatus is described in more detail with reference to FIG. 6.

In operation 320, the VQA apparatus may obtain candidate responses corresponding to the question using a VQA model (e.g., the VQA model 130 of FIG. 1). The VQA apparatus may obtain the candidate responses corresponding to a user's question using the VQA model that receives, as input, each visual/graphical content in a document corresponding to the candidate locations and the user's question. For example, some or all of the first candidate location, the second candidate location, up to the Nth candidate location (as obtained in operation 310) may be input to the VQA model, and candidate responses (e.g., a first candidate response of FIG. 8A and a second candidate response of FIG. 9A) may be obtained from the VQA model.

In operation 330, the VQA apparatus may obtain response confidences for the respective candidate responses, which may be done using the VQA model. The response confidence for a candidate response may be a numerical value (e.g., a score or probability) that indicates how appropriate the candidate response is to the user's question.

The VQA apparatus may obtain the response confidences by inputting a prompt defining a representation scheme of the response confidences to the VQA model along with each visual content and the user's question. For example, the prompt may include a scheme by which the response confidence is represented, such as “Tell me the confidence of the response as a score expressed as an integer between 0 and 10.”

The VQA apparatus may obtain the response confidences of the respective candidate responses using a confidence estimation model that estimates a response confidence of relevance of each of the candidate responses to the question. The confidence estimation model may be, but is not limited to, a transformer-based multi-modal base model.

In operation 340, the VQA apparatus may select the candidate response having the highest response confidence to be a target response. For example, the VQA apparatus may obtain a first candidate response and a second candidate response, and obtain a first response confidence and a second response confidence respectively corresponding to the first candidate response and the second candidate response. The VQA apparatus may select the first candidate response to be the target response when the first response confidence is greater than the second response confidence, or select the second candidate response to be the target response when the second response confidence is greater than the first response confidence.

In operation 350, the selected target response may be provided. For example, when the target response selected in operation 340 is the first candidate response, the first candidate response may be provided to an electronic device (e.g., a user terminal or a user computer) via a communication circuit (e.g., the communication circuit 1030 of FIG. 10), or when the target response selected is the second candidate response, the second candidate response may be provided to an electronic device (e.g., a user terminal or a user computer) via a communication circuit (e.g., the communication circuit 1030 of FIG. 10).

The providing of the target response selected based on the confidences by the VQA apparatus is described in more detail with reference to FIGS. 8A, 8B, 9A and 9B.

FIG. 4 illustrates an example of obtaining context data using a summary information generation model, according to one or more embodiments.

Referring to FIG. 4, a VQA apparatus (e.g., the VQA apparatus 100 of FIG. 1) may obtain summary information from the summary information generation model 110 (e.g., the summary information generation model 110 of FIG. 1) to which a document (e.g., the document 104 of FIG. 1) is input, and may generate the context data 440 using the obtained summary information. The document may be a multi-page document. The document may include a page 402 including text images, a page 404 including pictures, and a page 406 including tables. A text image may be text expressed as an image. For example, the text image may be an image in a portable document format (PDF) document. Any page of a document may include any one or more instances of a text image, a picture, and a table.

The summary information generation model 110 may output summary information on a document using an input document. The summary information generation model 110 may be a multi-modal base model (e.g., an MM-LLM), and multiple modalities may be input to the summary information generation model 110. The summary information generation model 110 may be a lighter model than a VQA model. A lightweight model may be a model that uses a relatively small number of parameters and performs low-complexity calculations. The summary information generation model 110 may perform calculations with lower complexity than the VQA model, so the data processing speed may be fast.

When the page 402 including text images is input to the summary information generation model 110, the VQA apparatus may obtain first summary information 410. For example, when a text image is input to the VQA apparatus, the VQA apparatus may obtain text information summarizing the content of the text image from the summary information generation model 110.

When the page 404 including pictures is input to the summary information generation model 110, the VQA apparatus may obtain second summary information 420. For example, a page including a picture may be a picture of an item for sale, and the VQA apparatus may obtain text information summarizing information on the item.

When the page 406 including tables is input to the summary information generation model 110, the VQA apparatus may obtain third summary information 430. For example, a table may include items and numeric data for each item, and the VQA apparatus may obtain statistics about the numeric data for each item.

The VQA apparatus may input a prompt defining a scheme of generating the summary information to the summary information generation model 110 together with a document. The VQA apparatus may obtain summary information summarized in a scheme defined in the prompt from the summary information generation model 110. The prompt defining the scheme of generating the summary information may specify that the summary information is to include a location within the document of a portion to be summarized in the document and content summarizing the portion to be summarized in the document. The prompt defining the scheme of generating the summary information may specify that the summary information is to include a title of the document to be summarized, a keyword for the document, and/or a description of visual material included in the document. The prompt may include a scheme of generating the summary information such as, for example, “1. Provide a rough description of page 10 in less than 700 words, 2. Show the keywords in the third paragraph of page 10, 3. Explain the diagrams or pictures included in page 10, and 4. “Show the page number and line numbers in the summary document.”

The VQA apparatus may obtain location information of a portion to be summarized in the document from the summary information generation model 110. The location information of the portion may include, but is not limited to, a page number of a paragraph included in the document, a paragraph number, and coordinates that represent the paragraph. The summary information generation model 110 may provide coordinate information of a paragraph using a layout analysis tool. For example, the summary information generation model 110 may provide rectangular coordinates of a paragraph included in the document, rectangular coordinates of an image included in the document, and rectangular coordinates of a table included in the document using the layout analysis tool.

The VQA apparatus may generate the context data 440 including pieces of summary information for respective portions of the document and pieces of location information respectively corresponding to the portions. For example, the VQA apparatus may generate the context data 440 including the first summary information 410, the second summary information 420, the third summary information 430, and location information corresponding to the first summary information 410, location information corresponding to the second summary information 420, and location information corresponding to the third summary information 430. The context data 440 may include page information, coordinate information, and summary information. The page information may include a page number of a page including a portion of the document summarized, and the coordinate information may include coordinates of a point at which a paragraph included in the portion begins and coordinates of a point at which the paragraph ends on the page including the portion of the document. In brief, the context data 440 may be a combination of the pieces of summary information and pieces of information about their respective contexts in the document.

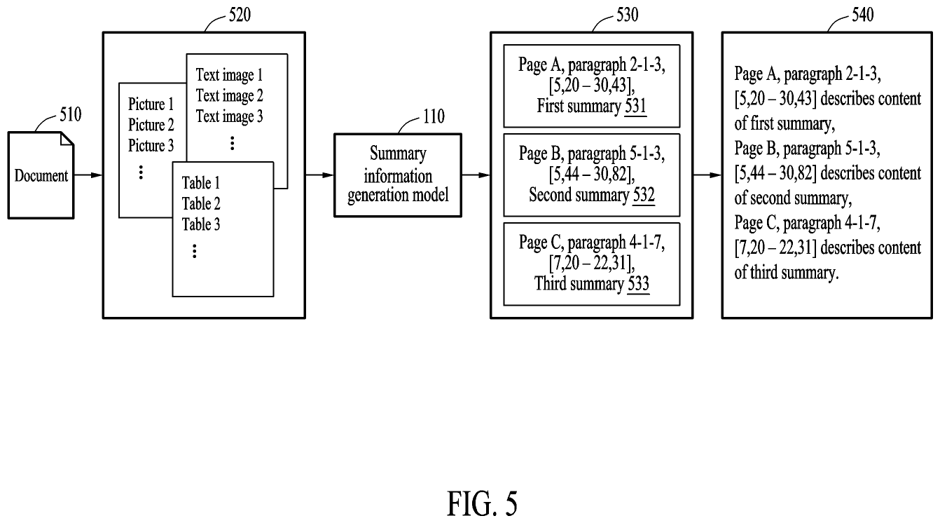

The generating of the summary information and the generating of the context data 440 based on the generated summary information by the VQA apparatus is described in more detail with reference to FIG. 5.

FIG. 5 illustrates an example of generating context data, according to one or more embodiments.

Referring to FIG. 5, a VQA apparatus (e.g., the VQA apparatus 100 of FIG. 1) may obtain summary information 530 from the summary information generation model 110 that receives pages 520 included in a document 510 as input. The VQA apparatus may generate context data 540 using the obtained summary information 530.

When the VQA apparatus receives the document 510, the VQA apparatus may input the pages 520 of the document 510 to the summary information generation model 110. The pages 520 may include a page (e.g., the page 402 including text images of FIG. 4) including text images and/or a page (e.g., the page 404 including pictures) including pictures, a page (e.g., the page 406 including tables) including tables, or any combination thereof. The VQA apparatus may input a prompt defining a scheme of generating the summary information to the summary information generation model 110 together with the document 510. For example, the scheme may specify a pattern of information to be generated for each document portion that has been summarized.

The VQA apparatus may obtain the summary information 530 from the summary information generation model 110. When the VQA apparatus inputs the prompt defining the scheme of generating the summary information to the summary information generation model 110 along with each page of the document 510, the VQA apparatus may obtain summary information expressed in the scheme defined by the input prompt.

For example, when the scheme defined in the input prompt is “page number including paragraph, paragraph number, [x-coordinate, y-coordinate indicating a starting point of paragraph—x-coordinate, y-coordinate indicating an ending point of paragraph], summary of paragraph,” the VQA apparatus may obtain first summary information 531, second summary information 532, and third summary information 533 generated according to the scheme defined in the prompt. The x-coordinate, y-coordinate indicating the starting point of the paragraph and the x-coordinate, y-coordinate indicating the ending point of the paragraph may each represent rectangular coordinates of an upper left portion of a box area including the paragraph and rectangular coordinates of a lower right portion of the box area including the paragraph. The prompt defining the scheme of generating the summary information may include instructing the pictures or tables included in the document 510 to always be treated as paragraphs or instructing to limit the amount of text information in the summary information.

The VQA apparatus may generate the context data 540 using the summary information 530. The VQA apparatus may generate the context data 540 using the first summary information 531, the second summary information 532, and the third summary information 533. The context data 540 may include page numbers of portions to be summarized in the document 510, paragraph numbers of the portions to be summarized, coordinate information of paragraphs of the portions to be summarized, and summary contents of a portion of the document 510.

FIG. 6 illustrates an example of obtaining location information using a candidate location extraction model, according to one or more embodiments.

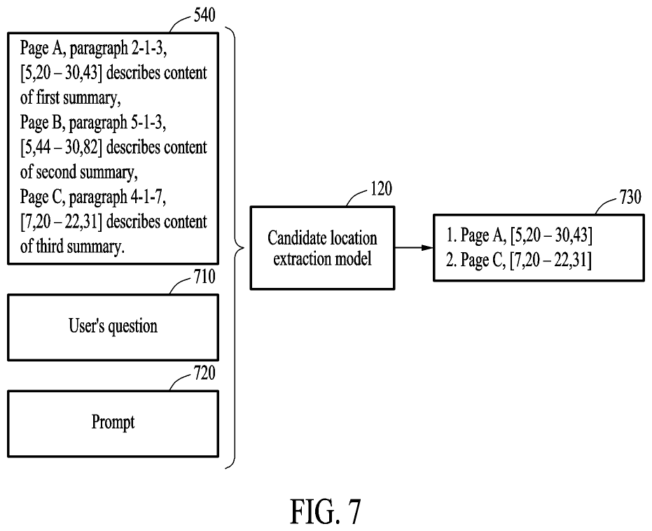

Referring to FIG. 6, a VQA apparatus may obtain location information for candidate locations within a document related to a question using the candidate location extraction model 120. The VQA apparatus may obtain the location information from the candidate location extraction model 120 that receives the context data 440, a prompt 602 requesting a candidate location, and a user's question 604 as input. The candidate location extraction model 120 may be a machine learning model based on multi-modal base data. For example, the candidate location extraction model 120 may be an MM-LLM. The location information may be a location of a portion to be summarized in a document (e.g., the document 104 of FIG. 1). The location information may include pieces of location information, for example, the location information may include first location information 610, second location information 620, third location information 630, to Nth location information 640. The obtaining of the location information by the VQA apparatus is described in more detail with reference to FIG. 7.

FIG. 7 illustrates an example of obtaining location information, according to one or more embodiments.

Referring to FIG. 7, a VQA apparatus (e.g., the VQA apparatus 100 of FIG. 1) may obtain location information on a candidate location from a candidate location extraction model. The VQA apparatus may input the context data 540 which is generated based on the prompt defining the scheme of generating summary information, a prompt 720 requesting a candidate location, and a user's question 710 to the candidate location extraction model. The VQA apparatus may obtain candidate locations 730 indicating locations within a document that may be used to answer the user's question from the candidate location extraction model. When the prompt defining the scheme of generating the summary information used to generate the context data 540 is, for example, “page number including paragraph, paragraph number, [x-coordinate, y-coordinate indicating a starting point of paragraph - x-coordinate, y-coordinate indicating an ending point of paragraph], summary of paragraph,” the candidate location 730 may be a candidate location having the form of “1. Page A, [5,20-30,43]/2. Page C, [7,20-22,31]” as shown in the example of FIG. 7. In sum, the candidate location extraction model 120 may infer which summaries best answer the user's question based on the prompt.

FIGS. 8A, 8B, 9A, and 9B illustrate examples of a VQA apparatus providing a target response using a VQA model, according to one or more embodiments.

Referring to FIG. 8A, a VQA apparatus may obtain a first candidate response 810 and a first response confidence 820, as inferred by the VQA model 130 that receives a page 802 including tables and the user's question 604 as input. The VQA model 130 is described in detail with reference to FIG. 2.

The VQA apparatus (e.g., the VQA apparatus 100 of FIG. 1) may obtain candidate responses 830 and 930 corresponding to a user's question 604, 806, or 906 using the VQA model 130 that receives each text image 804 or 904 in a document corresponding to candidate locations and the user's question 604, 806, or 906 as input. The VQA apparatus may obtain response confidences 840 or 940 indicating confidences of the respective candidate responses 830 and 930 using the VQA model 130. The VQA apparatus may obtain the response confidence 840 or 940 indicating the confidences of the respective candidate responses 830 and 930 using a confidence estimation model that estimates the response confidences 840 or 940 of the respective candidate responses 830 and 930 to a question. The confidence estimation model is described with reference to FIG. 2. The VQA apparatus may obtain the response confidence 840 or 940 by inputting a prompt defining a representation scheme of the response confidence to the VQA model 130 along with each visual content and the user's question. For example, the VQA apparatus may additionally input a prompt such as “Please express the response confidence as an integer between 0 and 10.” Next, a process of determining a confidence performed by a VQA model or confidence estimation model that receives two or more types of data as input is described.

The VQA model or confidence estimation model may be a multi-modal base model, and the multi-modal base model may include a natural language processing model and an image processing model to process different types of input data. When the input data is text data, the VQA model or the confidence estimation model may input the text data to a natural language processing model to obtain an output corresponding to the input text data and a confidence of the output corresponding to the text data from the natural language processing model. When the input data is image data, the VQA model or the confidence estimation model may input the image data to an image processing model to obtain an output corresponding to the input image data and a confidence of the output corresponding to the image data from the image processing model. The VQA model or the confidence estimation model may determine a simple average of the confidence of the output corresponding to the text data and the confidence of the output corresponding to the image data to be a final confidence, or may determine a weighted average of the confidence of the output corresponding to the text data and the confidence of the output corresponding to the image data to be the final confidence. The weighted average may be determining an average value by applying weights to the confidence of the output corresponding to the text data and the confidence of the output corresponding to the image data. The confidence (e.g., average) may be computed for each candidate summary.

The VQA apparatus may encode (or otherwise upscale) the resolution of visual content existing at a candidate location within a document into higher resolution visual content. The VQA apparatus may obtain high-resolution visual content by increasing the number of pixels of the visual content existing at the candidate location based on encoding. The VQA apparatus may obtain a response using the VQA model 130 that receives the high-resolution visual content as input. The VQA apparatus may require more detailed information on a particular page (or particular portion) of an input document to respond to a user's question. The VQA apparatus may prevent resource waste of the VQA apparatus and provide responses more efficiently by using high-resolution visual content for candidate locations instead of using the entire high-resolution document.

FIG. 8B illustrates an example of the embodiment of FIG. 8A. Referring to FIG. 8B, a VQA apparatus may input a page 804 including tables and a user's question 806 (“What is the total amount spent on the process?”) to the VQA model 130. The VQA apparatus may obtain a first candidate response 830 (“The amount used for the process out of the total expenditure is aaa won.”) and a first response confidence 840 (“Confidence: 9”) from the VQA model 130. The page 802 including tables may correspond to the page 804 including tables, and the user's question 604 may correspond to the user's question (“What is the total amount spent on the process?”) 806. The first candidate response 810 and the first response confidence 820 may correspond to the first candidate response (“The amount used for the process out of the total expenditure is aaa won”) 830 and the first response confidence (“Confidence: 9”) 840, respectively.

Referring to FIG. 9A, a VQA apparatus may obtain a second candidate response 910 and a second response confidence 920 from the VQA model 130 that receives a page 902 including visual/graphic content and the user's question 604 as input. The VQA model 130 is described in detail with reference to FIG. 2. Since the obtaining of the second candidate response 910 and the second response confidence 920 by the VQA apparatus is analogous to the obtaining of the first candidate response 810 and the first response confidence 820 by the VQA apparatus in FIG. 8, a repeated description thereof is omitted.

FIG. 9B illustrates an example of the embodiment of FIG. 9A. Referring to FIG. 9B, a VQA apparatus may input a page 904 including visual/graphic content and the user's question 906 (“What is the total amount spent on the process?”) to the VQA model 130. The VQA apparatus may obtain a second candidate response 940 (“The amount of labor costs is bbb won”) 930 and a second response confidence (“Confidence: 2”) from the VQA model 130. The page 902 including visual/graphic content may correspond to the page 904 including visual content, and the user's question 604 may correspond to the user's question 906 (“What is the total amount spent on the process?”). The second candidate response 910 and the second response confidence 920 may correspond to the second candidate response 930 (“The amount of labor costs is bbb won”) and the second response confidence 940 (“Confidence: 2”), respectively.

The VQA apparatus may select a candidate response having the highest response confidence among the response confidences 840 (e.g., the first response confidence (“Confidence: 9”) and the second response confidence 940 (“Confidence: 2”)) of the candidate responses (e.g., the first candidate response 830 (“The amount used for the process out of the total expenditure is aaa won”) and the second candidate response 930 (“The amount of labor costs is bbb won.”)) to be a target response, and provide the selected target response. In FIGS. 8B and 9B, the VQA apparatus may obtain the first response confidence 840 (“Confidence: 9”) and the second response confidence 940 (“Confidence: 2”), respectively, from the VQA model 130 in response to the user's question 806 and 906 (“What is the total amount spent on the process?”). The VQA apparatus may select the first candidate response 830 (“The amount used for the process out of the total expenditure is aaa won”) corresponding to the first response confidence 840 (“Confidence: 9”), which is the higher confidence among the first response confidence 840 (“Confidence: 9”) and the second response confidence 940 (“Confidence: 2”) 940, to be the target response, and provide the first candidate response 830 (“The amount used for the process out of the total expenditure is aaa won”).

FIG. 10 illustrates an example of configurations of a VQA apparatus, according to one or more embodiments.

Referring to FIG. 10, a VQA apparatus 1000 (e.g., the VQA apparatus 100 of FIG. 1) may include a memory 1010, a processor 1020, and the communication circuit 1030. The VQA apparatus 1000 may correspond to the VQA apparatus described in the present disclosure.

The memory 1010 may store instructions executable by the processor 1020. When executed by the processor 1020, the instructions executable by the processor 1020 may cause the processor 1020 to perform a VQA method. The memory 1010 may be integrated with the processor 1020. For example, random access memory (RAM) or flash memory may be arranged in an integrated circuit microprocessor and the like. In addition, the memory 1010 may include a separate device, such as a storage device that may be used by an external disk drive, a storage array, or a database system. The memory 1010 and the processor 1020 may be operatively integrated or may communicate with each other via an input/output (I/O) port, a network connection, or the like so that the processor 1020 may read a file stored in the memory 1010. The memory 1010 may be a non-transitory computer-readable storage medium that stores instructions. When executed by the processor 1020, the instructions stored in the memory 1010 may prompt at least one processor 1020 to cause the VQA apparatus 1000 to process data.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, a hard disk drive (HDD), a solid state drive (SSD), card memory (e.g., a multimedia card, a secure digital (SD) card, or an extreme digital (XD) card), magnetic tape, a floppy disk, a magneto-optical data storage device, an optical data storage device, a hard disk, a solid state disk, and other devices.

The communication circuit 1030 may communicate using a direct (e.g., wired) communication channel or a wireless communication channel between the VQA apparatus 1000 and an external electronic device (e.g., a user terminal device). The communication circuit 1030 may include one or more communication processors that operate independently of the processor 1020 and support direct (e.g., wired) or wireless communication. The communication circuit 1030 may be implemented as a single chip or as multiple chips. The communication circuit 1030 may receive a document including visual content and a query input including a user's question about the document. For example, the communication circuit 1030 may receive the document and the query input including the user's question from a mobile terminal (e.g., a smartphone).

The processor 1020 may execute instructions stored in the memory 1010. The processor 1020 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof. When the instructions are executed by the processor 1020, the processor 1020 may control the VQA apparatus 1000 to perform operations of the VQA method described in the present disclosure.

In an example, the VQA apparatus 1000 may receive a document including visual content and a query input including a user's question about the document, obtain summary information summarizing a portion of the document and location information indicating a location of the portion within the document using a summary information generation model that receives the document as input, generate context data including pieces of summary information for respectively corresponding portions of the document and the pieces of location information respectively corresponding to the portions, obtain location information on a candidate location in the document related to the user's question using a candidate location extraction model that receives a prompt requesting the candidate location in the document related to the user's question, the context data, and the user's question as input, obtain a response corresponding to the user's question using a VQA model that receives the visual content in the document corresponding to the candidate location and the user's question as input, and provide the obtained response.

The VQA apparatus 1000 may obtain the summary information and the location information by inputting a prompt defining a scheme/pattern (e.g.,. layout and content) of generating the summary information to the summary information generation model together with the document.

The VQA apparatus 1000 may generate context data including page information indicating a page number of a page in the document including a portion of the document to be summarized, coordinate information including coordinates of a point at which a paragraph included in the portion of the document begins and coordinates of a point at which the paragraph ends on the page including the portion of the document, and the summary information.

The VQA apparatus 1000 may obtain location information on candidate locations in the document related to the user's question using the candidate location extraction model, obtain candidate responses corresponding to the user's question using the VQA model that receives as input each visual content in the document corresponding to the plurality of candidate positions and the user's question, select a target response among the obtained candidate responses, and provide the selected target response.

The VQA apparatus 1000 may encode the resolution of visual content existing at a candidate location within the document into higher resolution visual content, and obtain a response using the VQA model that receives the higher resolution visual content as input.

The VQA apparatus 1000 may obtain a response confidence indicating a confidence of each of the candidate responses using the VQA model, and select a candidate response having the highest response confidence among the response confidences of the candidate responses to be the target response.

The VQA apparatus 1000 may obtain the response confidence by inputting a prompt defining a representation scheme of the response confidence to the VQA model along with each visual content and the user's question.

The VQA apparatus 1000 may obtain the response confidence indicating the confidence of each candidate response using a confidence estimation model that estimates the response confidence of each candidate response to the question, and select a candidate response having the highest response confidence among the response confidences of the candidate responses to be the target response. The selected target response may be provided to the user.

The computing apparatuses, the electronic devices, the processors, the memories, the displays, the information output system and hardware, the storage devices, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A computing apparatus, comprising:
one or more processors; and
a memory storing instructions configured to cause the one or more processors to:
receive a document comprising graphic content and receive a query input comprising a user's question about the document,
obtain summaries of respective portions of the document and locations of the respective portions within the document using a summary information generation model that performs inference on the document as input thereto,
generate context data comprising the summaries and the locations respectively corresponding to the portions,
obtain a candidate location in the document related to the user's question using a candidate location extraction model that infers the candidate location based on a prompt requesting the candidate location in the document related to the user's question, the context data, and the user's question, which are received as input to the candidate location extraction model,
obtain a response corresponding to the user's question using a visual question answering (VQA) model that receives the graphic content in the document corresponding to the candidate location and the user's question as input, and
provide the obtained response.

2. The computing apparatus of claim 1, wherein the instructions are further configured to cause the one or more processors to,
obtain candidate locations, including the candidate location, in the document related to the user's question using the candidate location extraction model,
obtain candidate responses corresponding to the user's question using the VQA model that receives each items of graphic content in the document respectively corresponding to the candidate locations and the user's question as input,
select one of the candidate responses as the obtained response.

3. The computing apparatus of claim 2, wherein the instructions are further configured to cause the one or more processors to,
obtain response confidences indicating confidences of the candidate responses, respectively, using the VQA model, and
select the one of the candidate responses based on it having the highest response confidence among the response confidences of the candidate responses.

4. The computing apparatus of claim 2, wherein the instructions are further configured to cause the one or more processors to,
obtain response confidences indicating confidences of the candidate responses, respectively, using a confidence estimation model that estimates the response confidence of each of the candidate responses with respect to the user's question, and
select the one of the candidate responses based on it having the highest response confidence among the response confidences of the candidate responses.

5. The computing apparatus of claim 1, wherein the instructions are further configured to cause the one or more processors to,
obtain the summaries and the locations by inputting a prompt defining a scheme of generating the summaries to the summary information generation model together with the document.

6. The computing apparatus of claim 3, wherein the instructions are further configured to cause the one or more processors to,
obtain the response confidences by inputting a prompt defining a representation scheme of the response confidences to the VQA model together with each of the items of graphic content and the user's question.

7. The computing apparatus of claim 5, wherein, the prompt defining the scheme of generating the summary information specifies that the summary information is to include a location within the document of a portion to be summarized in the document and content summarizing the portion to be summarized in the document.

8. The computing apparatus of claim 7, wherein, the prompt defining the scheme of generating the summary information specifies that the summary information is to include a title of the document to be summarized, a keyword for the document, and/or a description of graphic material included in the document.

9. The computing apparatus of claim 1, wherein the instructions are further configured to cause the one or more processors to,
encode a resolution of the graphic content existing at the candidate location in the document into higher resolution graphic content, and obtain the response using the VQA model that receives the higher resolution graphic content as input.

10. The computing apparatus of claim 1, wherein the instructions are further configured to cause the one or more processors to,
generate the context data comprising page information indicating a page number of a page including a portion of the document that is summarized, coordinate information including coordinates of a point at which a paragraph included in the portion starts and coordinates of a point at which the paragraph ends, and the summary.

11. A visual question answering (VQA) method performed by a computing apparatus, the method comprising:
receiving a document comprising graphic content and a query input comprising a user's question about the document;
obtaining summaries of respective portions of the document and locations of the respective portion within the document using a summary information generation model that performs inference on the document as input thereto;
generating context data comprising the summaries and the locations respectively corresponding to the portions;
obtaining a candidate location in the document related to the user's question using a candidate location extraction model that infers the candidate location based on a prompt requesting the candidate location in the document related to the user's question, the context data, and the user's question, which are received as input to the candidate location extraction model;
obtaining a response corresponding to the user's question using a visual question answering (VQA) model that receives the graphic content in the document corresponding to the candidate location and the user's question as input; and
providing the obtained response.

12. The method of claim 11, wherein the obtaining of the location information on the candidate location in the document comprises,
obtaining candidate locations, including the candidate location, in the document related to the user's question using the candidate location extraction model,
obtaining candidate responses corresponding to the user's question using the VQA model that receives each items of graphic content in the document respectively corresponding to the candidate locations and the user's question as input,
selecting one of the candidate responses as the obtained response.

13. The method of claim 12, further comprising:
obtaining response confidences indicating confidences of the candidate responses, respectively, using the VQA model, and
selecting the one of the candidate responses based on it having the highest response confidence among the response confidences of the candidate responses.

14. The method of claim 12, further comprising:
obtaining response confidences indicating confidences of the candidate responses, respectively, using a confidence estimation model that estimates the response confidence of each of the plurality of candidate responses with respect to the user's question, and
selecting the one of the candidate responses based on it having the highest response confidence among the response confidences of the candidate responses.

15. The method of claim 11, further comprising,
obtaining the summaries and the locations by inputting a prompt defining a scheme of generating the summaries to the summary information generation model together with the document.

16. The method of claim 13, further comprising,
obtaining the response confidences by inputting a prompt defining a representation scheme of the response confidences to the VQA model together with each of the items of graphic content and the user's question.

17. The method of claim 15, wherein the prompt defining the scheme of generating the summary information specifies that the summary information is to include a location within the document of a portion to be summarized in the document and content summarizing the portion to be summarized in the document.

18. The method of claim 17, wherein, the prompt defining the scheme of generating the summary information specifies that the summary information is to include a title of the document to be summarized, a keyword for the document, and/or a description of graphic material included in the document.

19. The method of claim 11, wherein, the obtaining of the response comprises,
encoding a resolution of the graphic content existing at the candidate location in the document into higher resolution graphic content, and obtaining the response using the VQA model that receives the higher resolution graphic content as input.

20. The method of claim 11, further comprising,
generating the context data comprising page information indicating a page number of a page including a portion of the document that is summarized, coordinate information including coordinates of a point at which a paragraph included in the portion starts and coordinates of a point at which the paragraph ends, and the summary.
